(19) United States
(12) Patent Application Publication
(10) Pub. No.: US 2019/0344797 A1
(43) Pub. Date: Nov. 14, 2019

(54) METHOD AND SYSTEM FOR CUSTOMIZING A DRIVING BEHAVIOR OF AN AUTONOMOUS VEHICLE

(71) Applicant: GM GLOBAL TECHNOLOGY OPERATIONS LLC, Detroit, MI (US)

(72) Inventors: Praveen Palanisamy, Sterling Heights, MI (US); Kausalya Singuru, Troy, MI (US)

(21) Appl. No.: 15/976,191

(22) Filed: May 10, 2018

(51) Int. Cl. B60W 40/09; G05D 1/02; G05D 1/00; B60W 50/08; B60W 50/10; G01C 21/34

(52) U.S. Cl. CPC B60W 40/09; G05D 1/0221; G05D 1/0088; B60W 2720/10; B60W 50/10; G01C 21/3484; B60W 2750/308; B60W 50/085

(57) ABSTRACT

A system and method for customizing a driving behavior of an autonomous vehicle is disclosed. The method includes receiving, by a controller of the autonomous vehicle, at least one user preference. The at least one user preference relates to a preferred driving behavior. The method also includes modifying a pre-programmed driving behavior of the autonomous vehicle based on the received at least one user preference. The method also includes instructing the autonomous vehicle to drive according to the modified driving behavior.

### INTRODUCTION

The subject embodiments relate to customizing a driving behavior of an autonomous vehicle. Specifically, one or more embodiments can be directed to customizing a driving behavior based on at least one user preference. One or more embodiments can also enable the autonomous vehicle to engage in online learning in order to make improved driving decisions, for example.

An autonomous vehicle is generally considered to be a vehicle that is able to navigate through an environment without being directly guided by a human driver. The autonomous vehicle can use different methods to sense different aspects of the environment. For example, the autonomous vehicle can use global positioning system (GPS) technology, radar technology, laser technology, and/or camera/imaging technology to detect the road, other vehicles, and road obstacles.

### SUMMARY

In one exemplary embodiment, a method includes receiving, by a controller of an autonomous vehicle, at least one user preference. The at least one user preference relates to a preferred driving behavior. The method also includes modifying a pre-programmed driving behavior of the autonomous vehicle based on the received at least one user preference. The method also includes instructing the autonomous vehicle to drive according to the modified driving behavior.

In another exemplary embodiment, the modifying the pre-programmed driving behavior includes determining at least one weighted parameter based on the at least one user preference, and the modified driving behavior of the autonomous vehicle is based on the at least one determined weighted parameter.

In another exemplary embodiment, the at least one user preference relates to at least one of a plan objective, a curve behavior, a distance-keeping tolerance, a lane changing dynamic, a desire to overtake, and a politeness factor.

In another exemplary embodiment, modifying the pre-programmed driving behavior of the autonomous vehicle includes configuring the driving behavior to: (1) minimize a drive time for reaching a destination, (2) provide a comfortable ride for the user, or (3) pass through landmarks when travelling to the destination.

In another exemplary embodiment, modifying the pre-programmed driving behavior of the autonomous vehicle includes configuring the driving behavior to correspond to a more active behavior or a more passive behavior.

In another exemplary embodiment, modifying the pre-programmed driving behavior of the autonomous vehicle includes configuring the driving behavior to maintain a threshold following distance.

In another exemplary embodiment, modifying the pre-programmed driving behavior of the autonomous vehicle includes configuring the driving behavior to maintain a threshold speed when passing through a curve.

In another exemplary embodiment, modifying the pre-programmed driving behavior of the autonomous vehicle includes configuring the driving behavior to maintain a threshold distance ahead of a tailgating vehicle.

In another exemplary embodiment, modifying the pre-programmed driving behavior of the autonomous vehicle includes configuring the driving behavior to travel at a specific speed when passing other vehicles.

In another exemplary embodiment, instructing the autonomous vehicle to drive includes determining at least one action to perform using a reinforcement-learning system. The determining the at least one action to perform includes determining the action based at least on a state of the autonomous vehicle and the at least one weighted parameter.

In another exemplary embodiment, a system of an autonomous vehicle includes an electronic controller configured to receive at least one user preference. The at least one user preference relates to a preferred driving behavior. The electronic controller can also be configured to modify a pre-programmed driving behavior of the autonomous vehicle based on the received at least one user preference. The electronic controller can also be configured to instruct the autonomous vehicle to drive according to the modified driving behavior.

In another exemplary embodiment, the modifying the pre-programmed driving behavior includes determining at least one weighted parameter based on the at least one user preference, and the modified driving behavior of the autonomous vehicle is based on the at least one determined weighted parameter.

In another exemplary embodiment, the at least one user preference relates to at least one of a plan objective, a curve behavior, a distance-keeping tolerance, a lane changing dynamic, a desire to overtake, and a politeness factor.

In another exemplary embodiment, modifying the pre-programmed driving behavior of the autonomous vehicle includes configuring the driving behavior to: (1) minimize a drive time for reaching a destination, (2) provide a comfortable ride for the user, or (3) pass through landmarks when travelling to the destination.

In another exemplary embodiment, modifying the pre-programmed driving behavior of the autonomous vehicle includes configuring the driving behavior to correspond to a more active behavior or a more passive behavior.

In another exemplary embodiment, modifying the pre-programmed driving behavior of the autonomous vehicle includes configuring the driving behavior to maintain a threshold following distance.

In another exemplary embodiment, modifying the pre-programmed driving behavior of the autonomous vehicle includes configuring the driving behavior to maintain a threshold speed when passing through a curve.

In another exemplary embodiment, modifying the pre-programmed driving behavior of the autonomous vehicle includes configuring the driving behavior to maintain a threshold distance ahead of a tailgating vehicle.

In another exemplary embodiment, modifying the pre-programmed driving behavior of the autonomous vehicle includes configuring the driving behavior to travel at a specific speed when passing other vehicles.

In another exemplary embodiment, instructing the autonomous vehicle to drive includes determining at least one action to perform using a reinforcement-learning system. The determining the at least one action to perform includes determining the action based at least on a state of the autonomous vehicle and the at least one weighted parameter.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 illustrates an example process of customizing a driving behavior of an autonomous vehicle in accordance with one or more embodiments;

FIG. 2 illustrates two example scenarios that a vehicle can encounter in accordance with one or more embodiments;

FIG. 3 illustrates an example tuner for a user to adjust one or more user preferences that determine an adaptive behavior in accordance with one or more embodiments;

FIG. 4 illustrates configuring a following distance that is to be maintained by the autonomous vehicle in accordance with one or more embodiments;

FIG. 5 illustrates configuring a speed by which a user vehicle should pass through a curve/turn in accordance with one or more embodiments;

FIG. 6 illustrates configuring a distance that a user vehicle should attempt to maintain between the user vehicle and a tailgating vehicle in accordance with one or more embodiments;

FIG. 7 illustrates configuring a lane-changing speed that a user vehicle should use when passing another vehicle in accordance with one or more embodiments;

FIG. 8 illustrates customizing a driving behavior of an autonomous vehicle by using a reinforcement-learning system in accordance with one or more embodiments;

FIG. 9 depicts a flowchart of a method in accordance with one or more embodiments of the invention; and

FIG. 10 depicts a high-level block diagram of a computer system, which can be used to implement one or more embodiments of the invention.

### DETAILED DESCRIPTION

The following description is merely exemplary in nature and is not intended to limit the present disclosure, its application or uses. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

One or more embodiments are directed to a system and method for customizing a driving behavior of an autonomous vehicle. Specifically, one or more embodiments can allow a user to customize the driving behavior based on at least one user preference, for example. One or more embodiments can customize the autonomous vehicle's driving behavior to incorporate a user preference regarding lane changing, distance keeping, desire to overtake other vehicles, and/or politeness to other vehicles, etc.

Conventional autonomous vehicles are generally configured to rigidly adhere to a pre-programmed driving behavior. Specifically, the conventional approaches generally configure the driving behavior of autonomous vehicles to perform in a manner that suits the preferences of the general population. However, certain users can consider use of the pre-programmed driving behavior to provide an undesirable transportation experience.

In view of the shortcomings of the conventional approaches in providing a desirable transportation experience for those users who do not want the vehicle to operate in accordance with a pre-programmed driving behavior, one or more embodiments can allow such users to customize the driving behavior of the autonomous vehicle based at least on a user-specific preference. The driving behavior can be customized within certain safety limits.

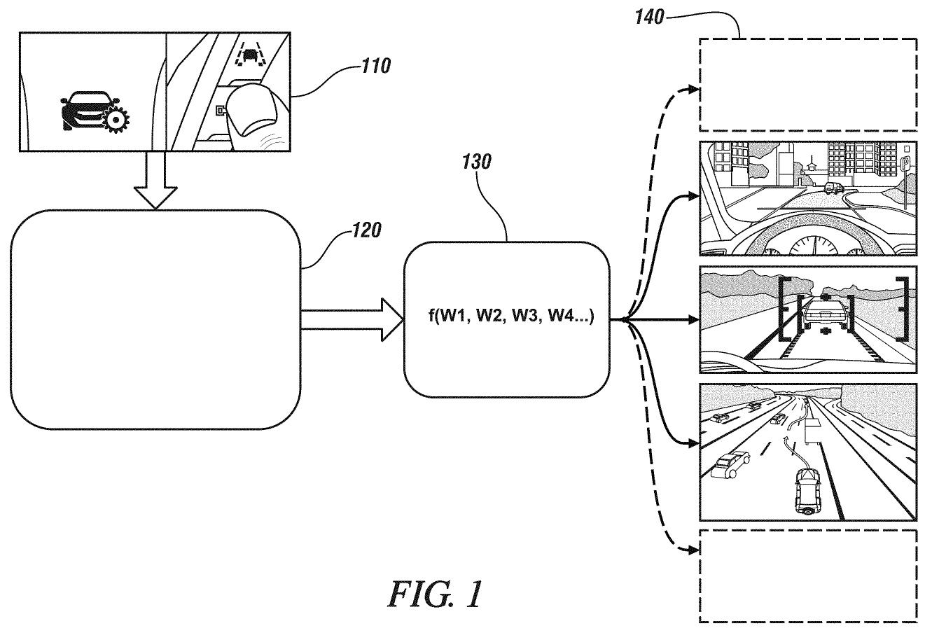

FIG. 1 illustrates an example process of customizing a driving behavior of an autonomous vehicle in accordance with one or more embodiments. At 110, a user/passenger of the autonomous vehicle can access user settings that allow the user to configure at least one user preference. The at least one user preference can be captured using an in-vehicle device or via any other method that can be used to capture the preferences. For example, the user preference can be captured by using a remote/mobile device, or by using an in-vehicle touch screen, and/or by a voice-activated device. In the example of FIG. 1, at 120, the user can adjust one or more user preferences that customize the driving behavior of the autonomous vehicle. The user preferences can relate to, but are not limited to, a plan objective, a curve behavior, a distance keeping tolerance, a lane change dynamic, a desire to overtake, and/or a politeness factor, for example. The user preferences can also relate to other vehicle behavior characteristics. Adjusting a plan objective of the vehicle can include configuring the driving behavior of the vehicle to: (1) minimize a drive time for reaching a destination, (2) provide a comfortable ride for the user/passenger, and/or (3) pass through landmarks when travelling to the destination.

Based on the one or more preferences that are adjusted by the user, at 130, one or more embodiments can determine a plurality of weighted parameters (i.e., W1, W2, W3, W4 . . . ). The weighted parameters can determine the customized/adaptive behavior that the autonomous vehicle will adhere to. At 140, as the vehicle encounters different driving scenarios, the vehicle will react to each scenario based on the determined customized/adaptive behavior.

If there is more than one user, the autonomous vehicle can use one or more preferences of one or more users. One or more embodiments can combine user preferences, which can result in an increased acceptability and trustworthiness of automated driving systems.

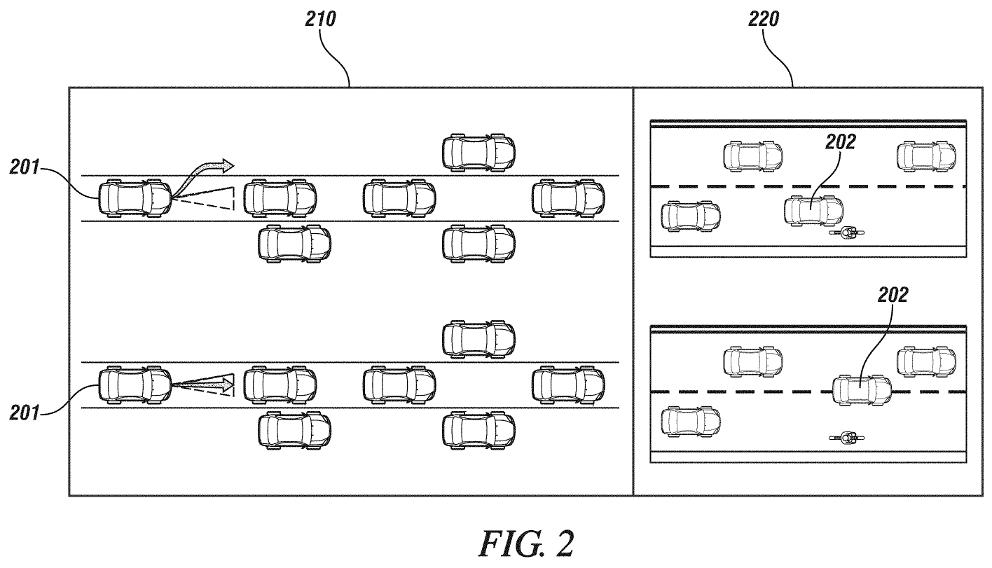

FIG. 2 illustrates two example scenarios that a vehicle can encounter in accordance with one or more embodiments. In example scenario 210, vehicle 201 can react in at least one of two ways to traffic that is ahead of vehicle 201. First, vehicle 201 can decide to pass the traffic by changing into the left lane if the weighted parameters of vehicle 201 determine an adaptive behavior that instructs vehicle 201 to change lanes, instructs vehicle 201 to overtake neighboring vehicles, and/or operates vehicle 201 in accordance with a lower politeness factor, for example. Alternatively, vehicle 201 can decide to stay behind the traffic by maintaining a configured threshold distance behind the traffic. Vehicle 201 can decide to stay behind the traffic if the weighted parameters of vehicle 201 determine an adaptive behavior that instructs vehicle 201 to stay within the lane, instructs vehicle 201 to not overtake neighboring vehicles, and/or operates vehicle 201 in accordance with a higher politeness factor, for example.

In example scenario 220, vehicle 202 can react in at least one of two ways to a bicyclist that is on the road. First, vehicle 202 can decide to drive in close proximity to the bicyclist when passing the bicyclist. Alternatively, vehicle 202 can decide to keep a far distance away from the bicyclist when passing the bicyclist. As previously described, vehicle 202 will react to each scenario based on the adaptive behavior of the vehicle 202.

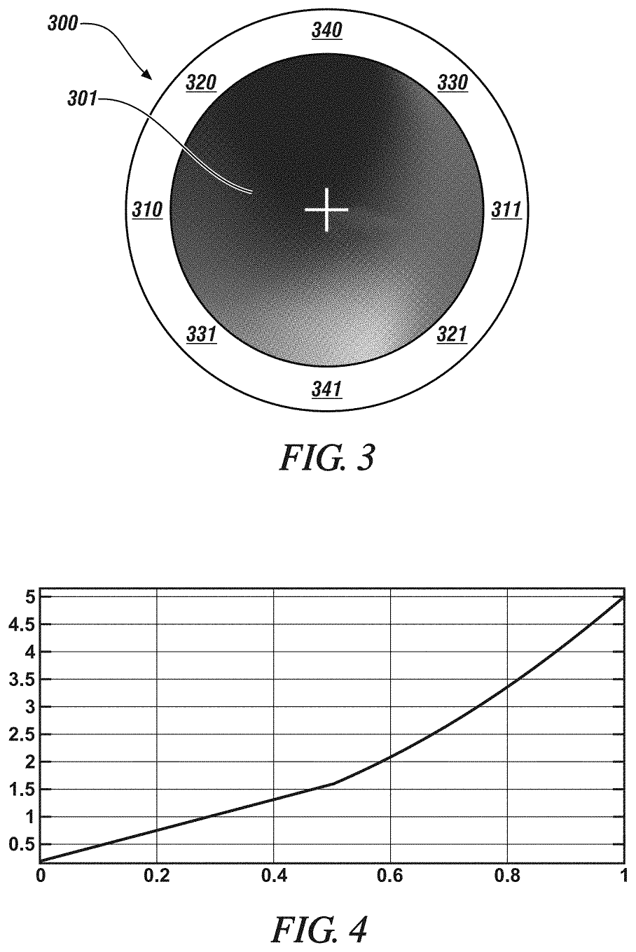

FIG. 3 illustrates an example tuner 300 for a user to adjust one or more user preferences that determine an adaptive behavior in accordance with one or more embodiments. The user can use example tuner 300 when adjusting one or more user-specific preferences at 120 (of FIG. 1), for example. As discussed above, other embodiments can use other methods to capture the user-specific preferences. The user can choose a point within region 301 of tuner 300, where the location of the specific point within region 301 will determine the weighted parameters that determine the customized/adaptive behavior. With regard to the left-to-right positioning of the chosen point within region 301, a chosen point that is near left region 310 will determine weighted parameters that correspond to an active behavior, while a chosen point that is near right region 311 will determine weighted parameters that correspond to a passive behavior. With regard to the top-to-bottom positioning of the chosen point within region 301, a chosen point that is near top region 340 will determine weighted parameters that correspond to positive/polite behavior, while a chosen point that is near bottom region 341 will determine weighted parameters that correspond to spirited/exciting behavior. With regard to the top-left to bottom-right positioning of the chosen point within region 301, a chosen point that is near top-left region 320 will determine weighted parameters that correspond to excited behavior, while a chosen point that is near bottom-right region 321 will determine weighted parameters that correspond to numb behavior. With regard to the bottom-left to top-right positioning of the chosen point within region 301, a chosen point that is near bottom-left region 331 will determine weighted parameters that correspond to active behavior, while a chosen point that is near top-right region 330 will determine weighted parameters that correspond to tranquil behavior. The center of region 301 corresponds to weighted parameters that correspond to indifferent behavior.

FIG. 4 illustrates configuring a following distance that is to be maintained by the autonomous vehicle in accordance with one or more embodiments. As previously described, a user can configure at least one preference that determines a plurality of weighted parameters. The weighted parameters can determine a customized/adaptive behavior of the autonomous vehicle. FIG. 4 illustrates how a following distance can be configured based on the weighted parameters. The following distance can correspond to a distance between the user's vehicle and a vehicle that is ahead of the user's vehicle. The following distance can be configured as a function of a behavior setting (where different values of the behavior setting are expressed along the x-axis of FIG. 4). Different values of following distances (expressed as distances that are travelled by the user's vehicle in different timeframes) are expressed along the y-axis of FIG. 4. In the example of FIG. 4, the behavior setting can range from 0 to 1, for example. In the example of FIG. 4, if the weighted parameters configure a behavior setting to be “1,” then the user's vehicle will maintain a distance behind a neighboring vehicle, where the distance corresponds to a distance that is travelled by the user's vehicle in 5 seconds (i.e., a “5-second following distance.”). On the other hand, if the weighted parameters configure a behavior setting to be “0.2,” then the user's vehicle will maintain a distance behind the neighboring vehicle, where the distance corresponds to a distance that is travelled by the user's vehicle in 0.75 seconds.

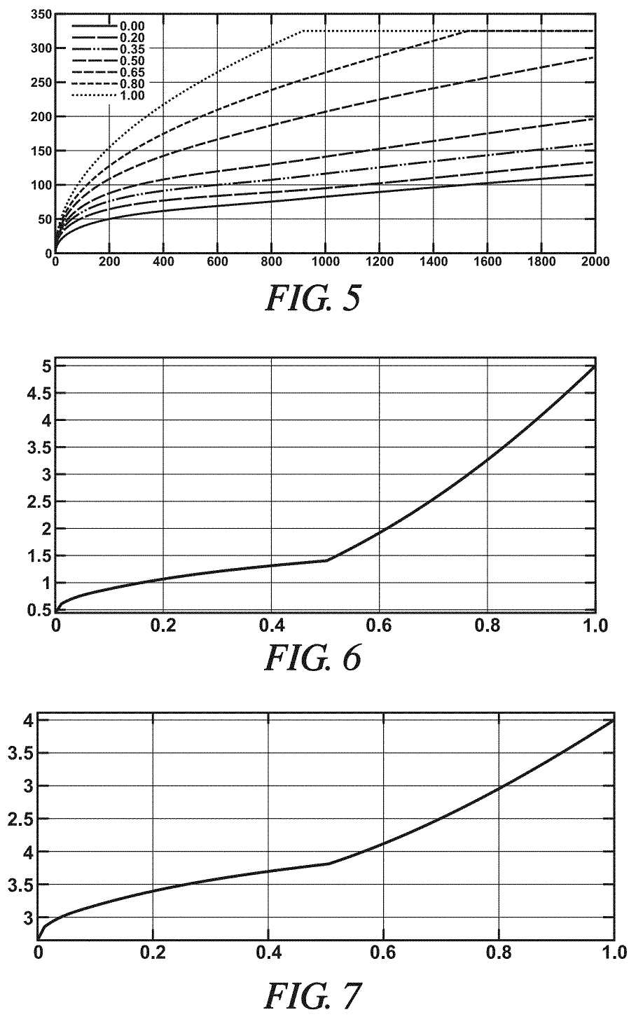

FIG. 5 illustrates configuring a speed by which a user vehicle should pass through a curve/turn in accordance with one or more embodiments. FIG. 5 illustrates how a curve speed can be configured based on the weighted parameters. The curve speed can be configured as a function of a behavior setting (where different values of the behavior setting are expressed as different curves in FIG. 5). The curve speed can also be configured as a function of a curve radius (where different values of the curve radius are expressed along the x-axis of FIG. 5). The behavior setting of FIG. 5 can be the same as or can be different from the behavior setting of FIG. 4. Different values of curve speed are expressed along the y-axis of FIG. 5. In the example of FIG. 5, the behavior setting can range from 0 to 1. In the example of FIG. 5, if the weighted parameters configure a behavior setting to be “1,” and a radius of a curve that is encountered by the user vehicle is 1000 m, then the user's vehicle speed will be configured to be 325 km/hr. As such, the user's vehicle speed will be configured to be 325 km/hr when the user's vehicle passes through the curve. On the other hand, if the weighted parameters configure a behavior setting to be “0.5,” and a radius a curve is 200 m, then the user's vehicle speed will be configured as 125 km/hr when the user's vehicle passes through the curve. In the future, autonomous vehicles can be permitted to operate at speed limits that are greater than current limits. The speeds listed in the example of FIG. 5 correspond to projected speeds that can possibly be used by autonomous vehicles in the future. However, other embodiments can different ranges of speeds, where the ranges can correspond to lower or higher speeds than the speeds utilized in the example of FIG. 5.

FIG. 6 illustrates configuring a distance that a user vehicle should attempt to maintain between the user vehicle and a tailgating vehicle in accordance with one or more embodiments. FIG. 6 illustrates how the distance can be configured based on the weighted parameters. The distance can be configured as a function of a behavior setting (where different values of the behavior setting are expressed along the x-axis in FIG. 6). The behavior setting of FIG. 6 can be the same as or can be different from the previously-described behavior settings. Different values of distance are expressed along the y-axis of FIG. 6. In the example of FIG. 6, if the weighted parameters configure a behavior parameter of “1,” then the user's vehicle will maintain a distance ahead of the tailgating vehicle, where the distance corresponds to a distance that is travelled by the tailgating vehicle in 5 seconds. On the other hand, if the weighted parameters configure a behavior parameter of “0.5,” then the user's vehicle will maintain a distance ahead of the tailgating vehicle, where the distance corresponds to a distance that is travelled by the tailgating vehicle in about 1.4 seconds, for example.

FIG. 7 illustrates configuring a lane-changing speed that a user vehicle should use when passing another vehicle in accordance with one or more embodiments. The lane-changing speed can be configured as a function of a behavior setting (where different values of the behavior setting are expressed along the x-axis in FIG. 7). The behavior setting of FIG. 7 can be the same as or can be different from the previously-described behavior settings. Different values of lane-changing speed are expressed along the y-axis of FIG. 7. In the example of FIG. 7, the lane-changing speed can correspond to a passing speed that the user's vehicle should travel at when passing another vehicle. In the example of FIG. 7, if the weighted parameters configure a behavior setting of “1,” then the user's vehicle will travel faster than a neighboring vehicle by 4 m/s when attempting to pass the neighboring vehicle. On the other hand, if the weighted parameters configure a behavior setting of “0.5,” then the user's vehicle will travel faster than a neighboring vehicle by 1.75 m/s when attempting to pass the neighboring vehicle.

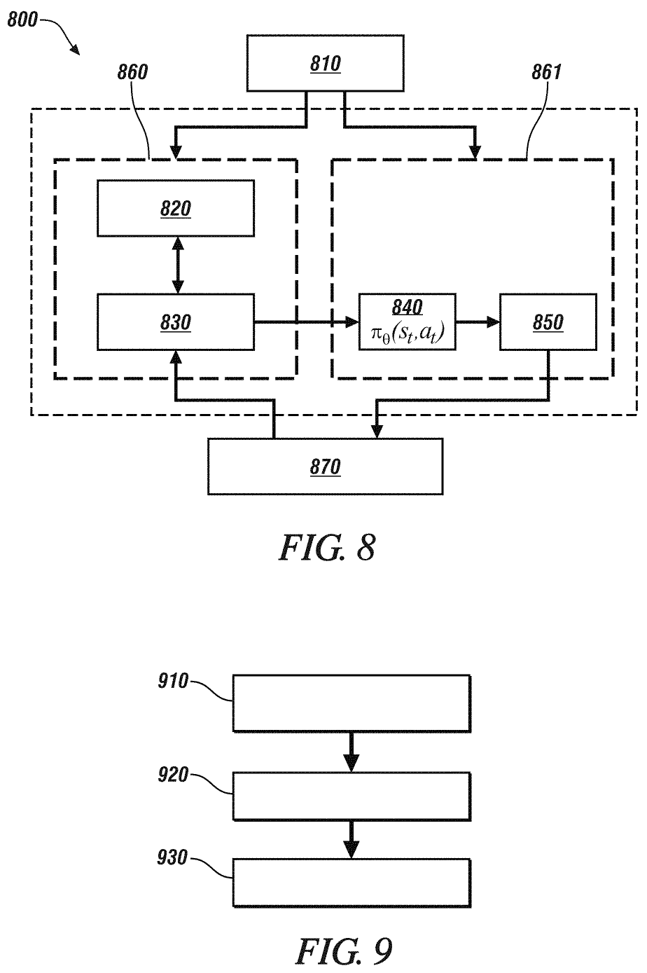

FIG. 8 illustrates customizing a driving behavior of an autonomous vehicle by using a reinforcement-learning system 800 in accordance with one or more embodiments. System 800 can be implemented as a deep neural network, for example. With one or more embodiments, the reinforcement learning system 800 can use an actor-critic framework. With the actor-critic framework, the reinforcement-learning system 800 includes a computer-implemented critic 860 and a computer-implemented actor 861. Based on a vehicle state and the previously-described weighted parameters, the computer-implemented actor 861 selects and performs different actions within a driving environment 870. The vehicle state can include any detectable characteristic regarding the vehicle such as, for example, vehicle speed, vehicle breaking, vehicle acceleration, vehicle turning, proximity to other objects, speed relative to other vehicles, etc. The computer-implemented critic 860 learns the effects of the different actions taken by the actor 861, and the critic 860 informs the computer-implemented actor 861 how to perform subsequent actions in order to maximize a computer-implemented reward. Therefore, based on different vehicle states and different weighted parameters, the reinforcement learning system 800 can learn the actions to take in the driving environment 870 over time. The example of FIG. 8 uses Q-learning to determine an optimal policy of taking steps from a current vehicle state to maximize the reward.

In the example of FIG. 8, information regarding vehicle state 810 can be input into the computer-implemented critic 860. Computer-implemented critic 860 can store and apply a state-action-value function 820 that governs the relationship between vehicle state, reward, actions, and weighted parameters. In one example, the state-action-value function 820 can be defined as follows:

Q(sₜ,aₜ)=Q(sₜ,aₜ)+αΔQ(sₜ,aₜ,W₁, . . . ,Wₙ)

Where,

ΔQ(sₜ,aₜ,W₁, . . . ,Wₙ)=[r+γ max(Q(sₜ₊₁,aₜ₊₁,W₁, . . . ,Wₙ))−Q(sₜ,aₜ,W₁, . . . Wₙ)]

where sₜ corresponds to the current vehicle state, sₜ₊₁ corresponds to a new vehicle state, aₜ corresponds to a current action, aₜ₊₁ corresponds to a new action, w₁ . . . wₙ correspond to the previously-described weighted parameters, r corresponds to a reward on transition from the current vehicle state to the new vehicle state, α corresponds to a learning rate, and γ corresponds to a discount rate.

Computer-implemented critic 860 can also include a temporal difference learning system 830 that allows the reinforcement-learning system 800 to learn which actions to take under which vehicle states. One way of learning which actions to take is by calculating a temporal difference error. In one example, temporal difference learning system 830 can determine the temporal difference error by using the following equation:

δₜ=rₜ₊₁+γQ(sₜ₊₁,aₜ₊₁,W₁, . . . Wn)−Q(sₜ,aₜ,W₁, . . . Wₙ)

With one embodiment, computer-implemented actor 861 can select an action based on a vehicle state, and weighted parameters, and a policy 840 (i.e., π_{θ}) that can be based on the state-action-value function 820. The action can also be based on input provided by temporal difference learning system 830, as described in more detail below.

The selected action 850 can then be executed by a controller in the driving environment 870. Feedback from the driving environment 870 can then be provided back to temporal difference learning system 830. Temporal difference learning system 830 can then provide input to actor 861, where actor 861 can use the input to determine a subsequent action, for example. Therefore, in view of the above, a reinforcement-learning-system can enable an autonomous vehicle to learn the different actions to take during runtime based on a customized driving behavior.

FIG. 9 depicts a flowchart of a method in accordance with one or more embodiments. The method of FIG. 9 can be performed in order to customize a driving behavior of an autonomous vehicle. The method of FIG. 9 can be performed by a controller in conjunction with one or more vehicle sensors and/or camera devices. The controller can be implemented within an electronic control unit (ECU) of a vehicle, for example. The method of FIG. 9 can be performed by a vehicle controller that receives and processes imagery of a scene in which a vehicle is driven and then autonomously drives the vehicle based on the processing of the imagery. The method can include, at block 910, receiving, by a controller of an autonomous vehicle, at least one user preference, the at least one user preference relates to a preferred driving behavior. The method can also include, at block 920, modifying a pre-programmed driving behavior of the autonomous vehicle based on the received at least one user preference. The method can also include, at block 930, instructing the autonomous vehicle to drive according to the modified driving behavior.

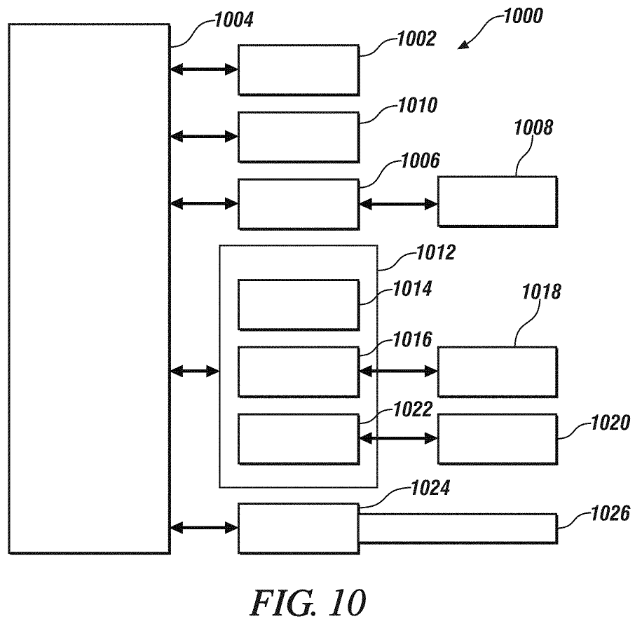

FIG. 10 depicts a high-level block diagram of a computing system 1000, which can be used to implement one or more embodiments. Computing system 1000 can correspond to, at least, a system that is configured to customize a driving behavior of an autonomous vehicle, for example. The system can be a part of a system of electronics within a vehicle that operates in conjunction with a camera and/or a sensor. With one or more embodiments, computing system 1000 can correspond to an electronic control unit (ECU) of a vehicle. Computing system 1000 can be used to implement hardware components of systems capable of performing methods described herein. Although one exemplary computing system 1000 is shown, computing system 1000 includes a communication path 1026, which connects computing system 1000 to additional systems (not depicted). Computing system 1000 and additional system are in communication via communication path 1026, e.g., to communicate data between them.

Computing system 1000 includes one or more processors, such as processor 1002. Processor 1002 is connected to a communication infrastructure 1004 (e.g., a communications bus, cross-over bar, or network). Computing system 1000 can include a display interface 1006 that forwards graphics, textual content, and other data from communication infrastructure 1004 (or from a frame buffer not shown) for display on a display unit 1008. Computing system 1000 also includes a main memory 1010, preferably random access memory (RAM), and can also include a secondary memory 1012. There also can be one or more disk drives 1014 contained within secondary memory 1012. Removable storage drive 1016 reads from and/or writes to a removable storage unit 1018. As will be appreciated, removable storage unit 1018 includes a computer-readable medium having stored therein computer software and/or data.

In alternative embodiments, secondary memory 1012 can include other similar means for allowing computer programs or other instructions to be loaded into the computing system. Such means can include, for example, a removable storage unit 1020 and an interface 1022.

In the present description, the terms “computer program medium,” “computer usable medium,” and “computer-readable medium” are used to refer to media such as main memory 1010 and secondary memory 1012, removable storage drive 1016, and a disk installed in disk drive 1014. Computer programs (also called computer control logic) are stored in main memory 1010 and/or secondary memory 1012. Computer programs also can be received via communications interface 1024. Such computer programs, when run, enable the computing system to perform the features discussed herein. In particular, the computer programs, when run, enable processor 1002 to perform the features of the computing system. Accordingly, such computer programs represent controllers of the computing system. Thus it can be seen from the forgoing detailed description that one or more embodiments provide technical benefits and advantages.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the embodiments not be limited to the particular embodiments disclosed, but will include all embodiments falling within the scope of the application.

What is claimed is:

1. A method, the method comprising:
receiving, by a controller of an autonomous vehicle, at least one user preference, wherein the at least one user preference relates to a preferred driving behavior;
modifying a pre-programmed driving behavior of the autonomous vehicle based on the received at least one user preference; and
instructing the autonomous vehicle to drive according to the modified driving behavior.

2. The method of claim 1, wherein the modifying the pre-programmed driving behavior comprises determining at least one weighted parameter based on the at least one user preference, and the modified driving behavior of the autonomous vehicle is based on the at least one determined weighted parameter.

3. The method of claim 1, wherein the at least one user preference relates to at least one of a plan objective, a curve behavior, a distance-keeping tolerance, a lane changing dynamic, a desire to overtake, and a politeness factor.

4. The method of claim 1, wherein modifying the pre-programmed driving behavior of the autonomous vehicle comprises configuring the driving behavior to: (1) minimize a drive time for reaching a destination, (2) prioritize providing a comfortable ride for the user, or (3) pass through landmarks when travelling to the destination.

5. The method of claim 1, wherein modifying the pre-programmed driving behavior of the autonomous vehicle comprises configuring the driving behavior to correspond to a more active behavior or a more passive behavior.

6. The method of claim 1, wherein modifying the pre-programmed driving behavior of the autonomous vehicle comprises configuring the driving behavior to maintain a threshold following distance.

7. The method of claim 1, wherein modifying the pre-programmed driving behavior of the autonomous vehicle comprises configuring the driving behavior to maintain a threshold speed when passing through a curve.

8. The method of claim 1, wherein modifying the pre-programmed driving behavior of the autonomous vehicle comprises configuring the driving behavior to maintain a threshold distance ahead of a tailgating vehicle.

9. The method of claim 1, wherein modifying the pre-programmed driving behavior of the autonomous vehicle comprises configuring the driving behavior to travel at a specific speed when passing other vehicles.

10. The method of claim 2, wherein instructing the autonomous vehicle to drive comprises determining at least one action to perform using a reinforcement-learning system, wherein the determining the at least one action to perform comprises determining the action based at least on a state of the autonomous vehicle and the at least one weighted parameter.

11. A system of an autonomous vehicle, comprising:
an electronic controller configured to:
receive at least one user preference, wherein the at least one user preference relates to a preferred driving behavior;
modify a pre-programmed driving behavior of the autonomous vehicle based on the received at least one user preference; and
instruct the autonomous vehicle to drive according to the modified driving behavior.

12. The system of claim 11, wherein the modifying the pre-programmed driving behavior comprises determining at least one weighted parameter based on the at least one user preference, and the modified driving behavior of the autonomous vehicle is based on the at least one determined weighted parameter.

13. The system of claim 11, wherein the at least one user preference relates to at least one of a plan objective, a curve behavior, a distance-keeping tolerance, a lane changing dynamic, a desire to overtake, and a politeness factor.

14. The system of claim 11, wherein modifying the pre-programmed driving behavior of the autonomous vehicle comprises configuring the driving behavior to: (1) minimize a drive time for reaching a destination, (2) prioritize providing a comfortable ride for the user, or (3) pass through landmarks when travelling to the destination.

15. The system of claim 11, wherein modifying the pre-programmed driving behavior of the autonomous vehicle comprises configuring the driving behavior to correspond to a more active behavior or a more passive behavior.

16. The system of claim 11, wherein modifying the pre-programmed driving behavior of the autonomous vehicle comprises configuring the driving behavior to maintain a threshold following distance.

17. The system of claim 11, wherein modifying the pre-programmed driving behavior of the autonomous vehicle comprises configuring the driving behavior to maintain a threshold speed when passing through a curve.

18. The system of claim 11, wherein modifying the pre-programmed driving behavior of the autonomous vehicle comprises configuring the driving behavior to maintain a threshold distance ahead of a tailgating vehicle.

19. The system of claim 11, wherein modifying the pre-programmed driving behavior of the autonomous vehicle comprises configuring the driving behavior to travel at a specific speed when passing other vehicles.

20. The system of claim 12, wherein instructing the autonomous vehicle to drive comprises determining at least one action to perform using a reinforcement-learning system, wherein the determining the at least one action to perform comprises determining the action based at least on a state of the autonomous vehicle and the at least one weighted parameter.
